(19) United States
(12) Patent Application Publication
(10) Pub. No.: US 2026/0094393 A1
(43) Pub. Date: Apr. 2, 2026

(54) IMAGE PROCESSING APPARATUS, IMAGE PROCESSING METHOD AND STORAGE MEDIUM

(71) Applicant: CANON KABUSHIKI KAISHA, Tokyo (JP)

(72) Inventors: TOMOYA SUDA, Tokyo (JP); MAHO MORI, Kanagawa (JP)

(21) Appl. No.: 19/338,952

(22) Filed: Sep. 24, 2025

(30) Foreign Application Priority Data
Oct. 1, 2024 (JP) 2024-172752

(51) Int. Cl. G06T 19/00; G06F 3/01; G06T 7/20; G06T 7/70; G06V 20/20; G06V 40/10

(52) U.S. Cl. CPC G06T 19/006; G06F 3/013; G06T 7/20; G06T 7/70; G06V 20/20; G06V 40/107; G06T 2200/24; G06T 2207/10016; G06T 2207/30196

(57) ABSTRACT

An image processing apparatus includes an acquisition unit that acquires a video image of a real space that is obtained by imaging an area in front of a user wearing the image processing apparatus, a region identification unit that identifies a region that is a candidate plane for displaying a user interface enabling the user to enter input in the video image of the real space based on an object included in the acquired video image of the real space, and a display control unit that controls display of a video image obtained by superimposing the user interface on the video image of the real space in the identified region.

### BACKGROUND

### Field of the Technology

The present disclosure relates to an image processing apparatus, an image processing method, and a storage medium.

### Description of the Related Art

In recent years, head-mounted display devices (HMDs) that viewers wear on their heads to view video images are increasingly used. One application of an HMD is to perform a task in a virtual reality space by capturing a video image of an external view using a camera of the HMD and displaying a video image generated by superimposing a monitor screen or an interface for input (hereinafter, also referred to as “input user interface (UI)”) on the captured video image. The task in the virtual reality space can be performed solely with the HMD without preparing a monitor or an input device, making it possible to perform the task anywhere.

Japanese Patent Laid-Open No. 2002-318652 describes a technology that recognizes a plane present relatively close to a user based on information acquired by a camera and superimposing and displaying an input UI on the recognized plane as an input UI of a wearable computer. Japanese Patent Laid-Open No. 2010-145861 is seen to discuss a technology that superimposes and displays a UI on an HMD that follows a hand of a user.

### SUMMARY

An image processing apparatus includes an acquisition unit configured to acquire a video image of a real space that is obtained by imaging an area in front of a user wearing the image processing apparatus, a region identification unit configured to identify a region that is a candidate plane for displaying a user interface enabling the user to enter input in the video image of the real space based on an object included in the acquired video image of the real space, and a display control unit configured to control display of a video image obtained by superimposing the user interface on the video image of the real space in the identified region.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an outline of a head-mounted display device.

FIG. 2 is a diagram illustrating an example of a hardware configuration of an image processing apparatus.

FIGS. 3A and 3B are diagrams illustrating a task in a virtual reality space.

FIG. 4 is a diagram illustrating an example of a functional configuration of an image processing apparatus according to a first embodiment.

FIG. 5 is a flowchart illustrating a process flow performed by the image processing apparatus according to the first embodiment.

FIG. 6 is a flowchart illustrating a process performed by a plane identification unit according to the first embodiment.

FIG. 7 is a schematic diagram illustrating an example of a plane detected by the plane identification unit.

FIG. 8 is a diagram illustrating an example of an initial settings screen related to identification of a plane for input user interface (input UI) placement.

FIG. 9 is a flowchart illustrating a process performed by a user interface (UI) identification unit according to the first embodiment.

FIGS. 10A and 10B are schematic diagrams illustrating an example of a region identified by a region identification unit and an example of an input UI.

FIG. 11 is a diagram illustrating an example of state transitions during a process according to the first embodiment.

FIG. 12A is a diagram illustrating an example of a UI for plane identification according to the first embodiment.

FIG. 12B is a diagram illustrating an example of a UI for region identification according to the first embodiment.

FIG. 12C is a diagram illustrating an example of a UI for input UI identification according to the first embodiment.

FIG. 13 is a diagram illustrating an example of a functional configuration of an image processing apparatus according to a second embodiment.

FIG. 14 is a flowchart illustrating a process flow performed by the image processing apparatus according to the second embodiment.

FIG. 15 is a diagram illustrating an example of a functional configuration of an image processing apparatus according to a third embodiment.

FIG. 16 is a flowchart illustrating a process flow performed by the image processing apparatus according to the third embodiment.

FIG. 17 is a flowchart illustrating a process performed by a hand state recognition unit according to the third embodiment.

FIG. 18 is a diagram illustrating an example of hand states recognized by the hand state recognition unit.

FIG. 19 is a flowchart illustrating a process performed by a determination unit according to the third embodiment.

FIG. 20 is a diagram illustrating an example of a functional configuration of an image processing apparatus according to a fourth embodiment.

FIG. 21 is a flowchart illustrating a process flow performed by the image processing apparatus according to the fourth embodiment.

FIG. 22 is a flowchart illustrating a process performed by a selection unit according to the fourth embodiment.

FIGS. 23A to 23C are diagrams illustrating examples of a two-handed input UI and a one-handed input UI.

FIG. 24 is a diagram illustrating an example of a functional configuration of an image processing apparatus according to a fifth embodiment.

FIG. 25 is a flowchart illustrating a process flow performed by the image processing apparatus according to the fifth embodiment.

FIG. 26 is a diagram illustrating an example of a data list.

FIG. 27 is a flowchart illustrating a process performed by a condition setting unit according to the fifth embodiment.

FIG. 28 is a diagram illustrating an example of a condition setting UI.

FIG. 29 is a flowchart illustrating a process performed by a hand state recognition unit according to the fifth embodiment.

FIG. 30 is a flowchart illustrating a process performed by a determination unit according to the fifth embodiment.

FIG. 31 is a flowchart illustrating a process performed by a selection unit according to the fifth embodiment.

### DESCRIPTION OF THE EMBODIMENTS

Embodiments of the present disclosure will be described with reference to the drawings. The embodiments described below are not intended to limit the present disclosure, and not all combinations of features described in the embodiments are necessarily essential to a solution provided by the present disclosure. Portions of the embodiments described below may be combined as needed. Components or the like that correspond or are similar to each other are assigned the same reference numeral, and redundant descriptions are omitted.

Conventional technologies may display a user interface (UI) at a position that is not intended by a user or may display a UI even when the user is not attempting to enter input into an input UI. In such cases, work efficiency decreases. The present disclosure is directed to displaying an input UI appropriately during a task in a virtual reality space.

### FIRST EMBODIMENT

A first embodiment describes an example of identifying placement of an interface for input (input user interface (input UI)) on a plane detected from an acquired external view video image based on the presence or absence of a specific object. The specific object herein refers to, for example, an object that may hinder a task performed by the user in a virtual reality space. Examples of the specific object may include an object that is placed on a desk and may become an obstacle when an input operation is performed, a document that is referenced or a memorandum that is used during a task in a virtual reality space, and the like. While a UI for inputting one or more characters using a single button and a UI for inputting a character by drawing the character are described as examples of the input UI in the present specification, the input UI is not limited to these examples.

### Configuration of Head-Mounted Display Device (HMD)

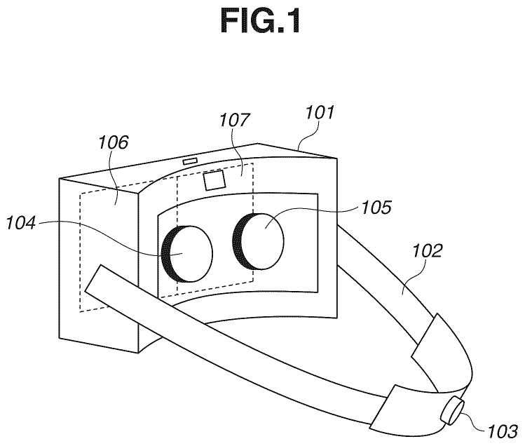

An outline of a head-mounted display device (HMD) will be described as an application example of an image processing apparatus according to the present embodiment with reference to FIG. 1. An HMD 101 includes a strap 102 used to mount the HMD 101 on the head of a viewer, a strap length adjustment portion 103, a left-eye eyepiece lens 104, a right-eye eyepiece lens 105, a left-eye display device 106, and a right-eye display device 107. When using the HMD 101, the viewer wears the HMD 101 on their head and adjusts the length of the strap 102 using the strap length adjustment portion 103. A video image input to the HMD 101 is composed of a left-side video image displayed on the left-eye display device 106 and a right-side video image displayed on the right-eye display device 107.

The viewer views the left-side video image through the left-eye eyepiece lens 104 with the left eye and views the right-side video image through the right-eye eyepiece lens 105 with the right eye. The left-eye display device 106 and the right-eye display device 107 may be separate left and right display devices or may be a single display device divided into left and right sections to display the left-side video image and the right-side video image.

### Hardware Configuration of Image Processing Apparatus

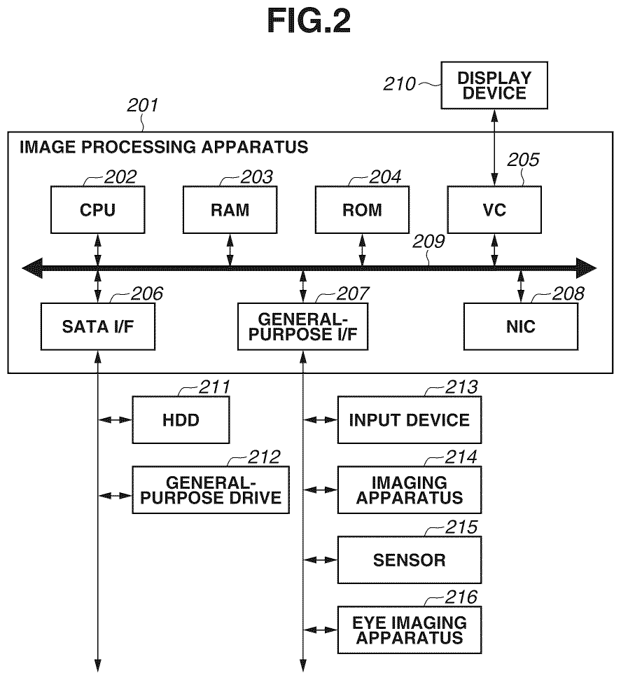

FIG. 2 is a diagram illustrating an example of a hardware configuration of an image processing apparatus 201 according to the present embodiment. The image processing apparatus 201 includes a central processing unit (CPU) 202, a random access memory (RAM) 203, and a read-only memory (ROM) 204. The image processing apparatus 201 includes a video card (VC) 205, a Serial Advanced Technology Attachment (SATA) interface (I/F) 206, a general-purpose I/F 207, a network interface card (NIC) 208, and a system bus 209.

The CPU 202 executes an operating system (OS) and various programs stored in the ROM 204, a hard disk drive (HDD) 211, or the like using the RAM 203 as a work memory. The CPU 202 controls each component of the image processing apparatus 201 via the system bus 209. Each process illustrated in a flowchart described below is executed by the CPU 202 by loading program codes stored in the ROM 204, the HDD 211, or the like into the RAM 203 and executing the loaded program codes.

A display device 210 such as a display is connected to the VC 205. The HDD 211, a general-purpose drive 212 for reading and writing various recording media, and the like are connected to the SATA I/F 206 via a serial bus. An input device 213, such as a mouse and a keyboard, an imaging apparatus 214, a sensor 215, an eye imaging apparatus 216, and the like are connected to the general-purpose I/F 207 via a bus such as a serial bus. The imaging apparatus 214 is configured to capture a video image of an area surrounding a user wearing the HMD 101. The sensor 215 is configured to acquire information about the area surrounding the user wearing the HMD 101. The eye imaging apparatus 216 refers to an eye camera configured to capture an image of an eye state of the user wearing the HMD 101. The NIC 208 performs input and output of information with an external apparatus. The CPU 202 uses various recording media mounted on the HDD 211 or the general-purpose drive 212 as various data storage locations. The CPU 202 displays a graphical user interface (GUI) provided by a program on the display device 210 and receives input, such as a user instruction, received via the input device 213.

### Jobs in Virtual Reality Space

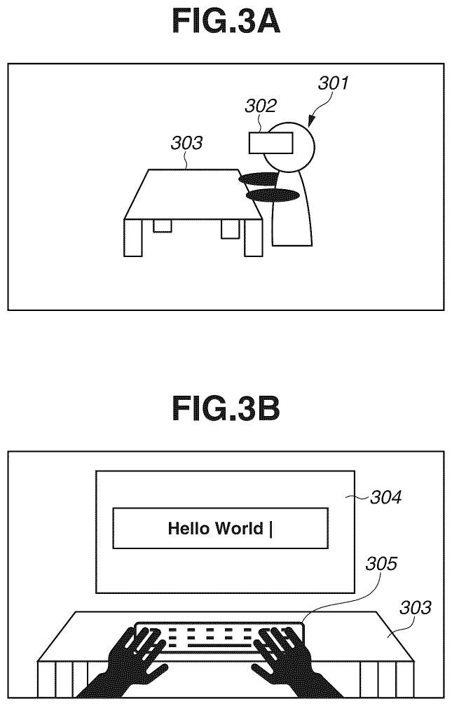

A task in a virtual reality space will be described with reference to FIGS. 3A and 3B. FIG. 3A illustrates an example of a user 301 wearing an HMD 302 and performing a task in a virtual reality space at a desk 303. FIG. 3B illustrates an example of a video image of the virtual reality space viewed by the user 301 illustrated in FIG. 3A via the HMD 302. As illustrated in FIG. 3B, a captured video image of a real space surrounding the user 301 is displayed with a video image of a monitor 304 and an input UI 305 superimposed on the displayed video image. Since the task in the virtual reality space illustrated in the example is performed using the monitor 304 and the input UI 305, only the HMD 302 is necessary to perform the task. During the task in the virtual reality space, for example, the user 301 issues an instruction to input text using the input UI 305, and the text specified in the instruction is input to the monitor 304, thereby displaying the text.

### Functional Configuration of Image Processing Apparatus

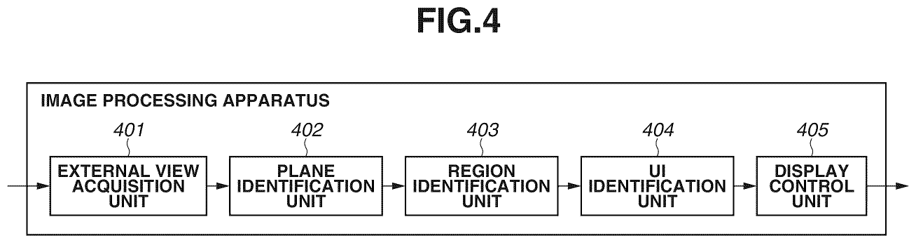

FIG. 4 is a diagram illustrating an example of a functional configuration of an image processing apparatus according to the first embodiment that is implemented using, for example, a circuit. The image processing apparatus according to the first embodiment includes an external view acquisition unit 401, a plane identification unit 402, a region identification unit 403, a UI identification unit 404, and a display control unit 405.

The external view acquisition unit 401 acquires a video image (external view video image) of an external view around the user wearing the HMD 101 (HMD wearer) based on an input from the imaging apparatus 214. The external view video image (external view video image) herein refers to a video image of the real space captured by the imaging apparatus 214 and including a scene (foreground) in front of the user wearing the HMD 101. In other words, the external view acquisition unit 401 acquires a video image of the real space based on a viewing direction (field of vision) of the HMD wearer. The external view acquisition unit 401 is an example of an acquisition unit. The plane identification unit 402 detects a candidate plane for input UI placement based on the video image of the external view acquired by the external view acquisition unit 401 and identifies a plane for input UI placement from the detected planes. The plane identification unit 402 is an example of a plane identification unit. The region identification unit 403 identifies a region for input UI placement within the plane for input UI placement identified by the plane identification unit 402. The region identification unit 403 identifies a region for displaying an input UI on the video image of the external view based on an object included in the acquired external view video image. The region identification unit 403 is an example of a region identification unit.

The UI identification unit 404 identifies an input UI to be displayed in the region for input UI placement identified by the region identification unit 403 based on the identified region. The UI identification unit 404 is an example of a user interface identification unit. The display control unit 405 controls the left-eye display device 106 and the right-eye display device 107 to display the external view video image with the input UI superimposed thereon in the virtual reality space. The display control unit 405 controls the left-eye display device 106 and the right-eye display device 107 to display a video image obtained by superimposing the input UI identified by the UI identification unit 404 onto the external view video image in the region identified by the region identification unit 403.

The display control unit 405 is an example of a display control unit.

### Process Performed by Image Processing Apparatus

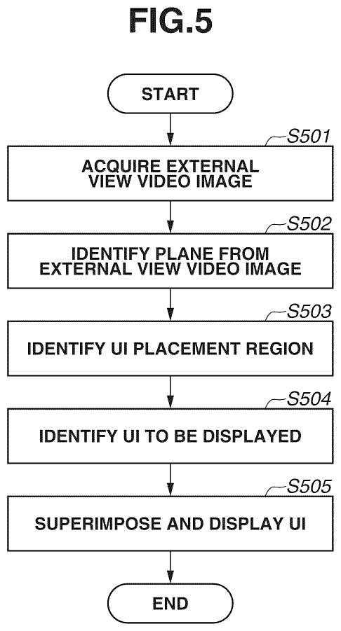

FIG. 5 is a flowchart illustrating a process flow performed by the image processing apparatus according to the first embodiment.

In step S501, the external view acquisition unit 401 acquires a video image (external view video image) of an external view around the user wearing the HMD 101 based on input from the imaging apparatus 214. As described above, the video image of the external view refers to a video image of the real space captured by the imaging apparatus 214 and including a foreground of the user wearing the HMD 101. The external view video image is acquired from the imaging apparatus 214, and in a case where the HMD 101 includes a plurality of imaging apparatuses 214, an external view video image is acquired using one or more imaging apparatuses 214.

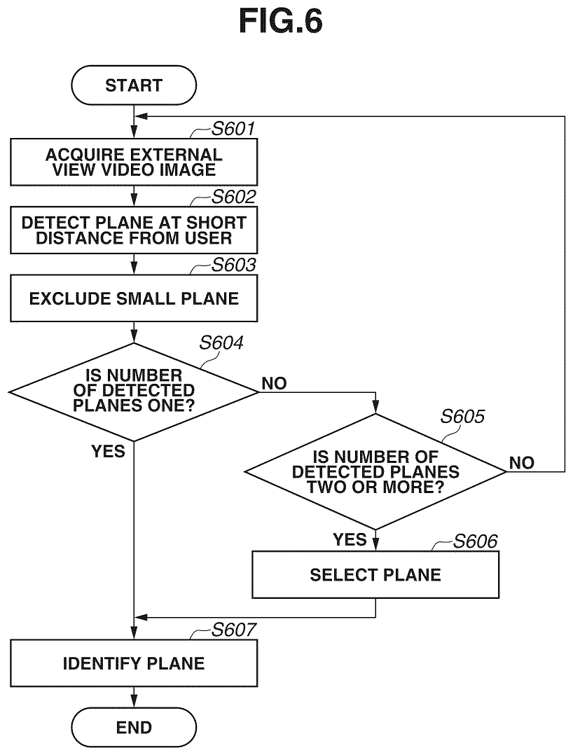

In step S502, the plane identification unit 402 detects a candidate plane for input UI placement based on the video image of the external view acquired in step S501 and identifies a plane for input UI placement from the detected planes. This process performed in step S502 by the plane identification unit 402 to identify a plane for input UI superimposition will be described with reference to FIG. 6.

In step S601 in FIG. 6, the plane identification unit 402 acquires the video image of the external view acquired in step S501 by the external view acquisition unit 401.

In step S602, the plane identification unit 402 detects a plane at a relatively short distance from the user on the video image of the external view based on the video image of the external view acquired in step S601. The plane at a relatively short distance from the user refers to, for example, a plane on an operable range of a hand of the user wearing the HMD 101. The plane can be detected using, for example, a method in which a plane is acquired from the external view video image by acquiring information indicating that the plane has been touched by a part of the body of the user, such as a finger, from the external view acquisition unit 401, or a publicly-known technique such as Random Sample Consensus (RANSAC) plane estimation from the sensor 215 of the HMD 101 or the external view video image can be used to detect a plane.

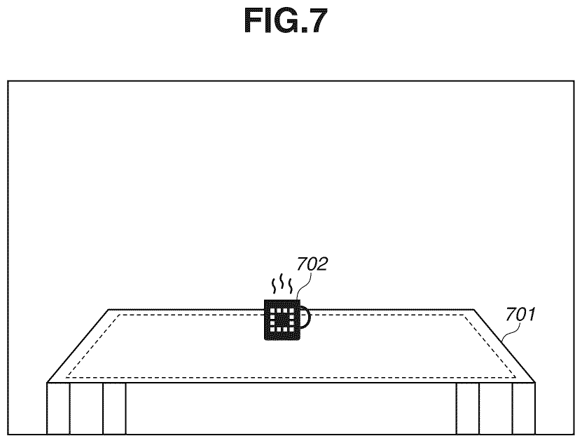

In step S603, the plane identification unit 402 performs processing to exclude a plane that is too small for input UI placement (superimposition) from the plane detected in step S602. This plane exclusion is performed by determining whether, for example, a result of acquiring the size of a plane in the real space from the sensor 215 of the HMD 101 or the like or a result of acquiring a ratio of the size of the external view video image acquired by the external view acquisition unit 401 to the size of a plane is greater than a threshold stored in advance. An example of a method for determining a plane size based on the acquired external view video image will now be described with reference to FIG. 7. FIG. 7 is a diagram illustrating an image obtained by cropping the external view video image acquired by the external view acquisition unit 401 to match the display field of view of the HMD 101, with a dotted line indicating a result of performing plane detection on the external view video image. FIG. 7 illustrates an example of a case where planes smaller than or equal to a threshold of one twentieth of the external view image are excluded using a resolution of 4096 [pix] vertically and 8192 [pix] horizontally. Here, [pix] refers to pixels. The external view video image illustrated as an example in FIG. 7 includes a desk 701 at the center, and a cup 702 is placed on the desk 701. Assume that two planes that are an upper plane of the desk 701 and a side plane of the cup 702 are detected as a result of plane detection performed by the plane identification unit 402. Also assume that a plane size calculation result based on coordinate information about the desk 701 is one sixth of the external view video image. In this case, since the upper plane of the desk 701 detected as a plane is greater than the threshold, the upper plane is not determined as an exclusion target. In another example, assume that a plane size calculation result based on coordinate information about the cup 702 is one thirty-fifth of the external view video image. In this case, since the side plane of the cup 702 detected as a plane is less than the threshold, the side plane is excluded from the planes identified as planes for input UI placement.

Returning to FIG. 6, in step S604, the plane identification unit 402 determines whether the number of planes detected as candidate planes for input UI placement is one. In a case where the plane identification unit 402 determines that the number of planes detected as candidate planes for input UI placement is one (YES in step S604), the processing proceeds to step S607. In a case where the plane identification unit 402 determines that the number of planes detected as candidate planes for input UI placement is not one (NO in step S604), the processing proceeds to step S605.

In step S605, the plane identification unit 402 determines whether the number of planes detected as candidate planes for input UI placement is two or more. In a case where the plane identification unit 402 determines that the number of planes detected as candidate planes for input UI placement is two or more (YES in step S605), the processing proceeds to step S606. In a case where the plane identification unit 402 determines that the number of planes detected as candidate planes for input UI placement is not two or more, i.e., in a case where the plane identification unit 402 determines that not a single candidate plane for input UI placement is detected (NO in step S605), the processing returns to step S601, and plane detection is performed again. At this time, the image processing apparatus notifies the user that plane detection will be performed again. For example, notification is provided to prompt the user to move nearby objects or utilize a part of the body, such as a hand, as a plane to facilitate detection of a candidate plane for input UI placement.

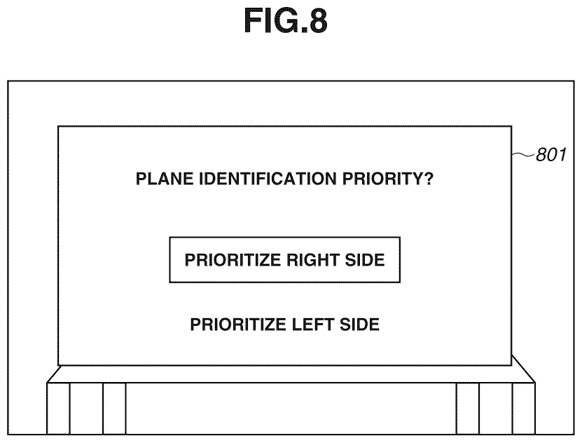

In step S606, the plane identification unit 402 selects a plane for input UI placement from the plurality of planes detected as candidate planes for input UI placement. The plane selection is performed using, for example, one or more of an identification method based on information from the user and an identification method based on a rule stored in the HMD 101. In the case of identifying a plane for input UI placement based on information from the user, a setting is configured on an initial settings screen illustrated as an example in FIG. 8. In the example illustrated in FIG. 8, a video image is displayed on the HMD 101 in a case where the user configures an initial setting for identification of a plane for input UI placement in a situation where tasks are performed in the virtual reality space illustrated in FIG. 3. In FIG. 8, a UI 801 is superimposed on the external view video image and displayed to prompt the user to select plane identification priority. In the example illustrated in FIG. 8, an instruction is issued to prioritize a right-side plane over a left-side plane when identifying a plane for input UI placement, so that the right-side plane is preferentially identified as a plane for input UI placement. While priority is described as an example, information obtained from the user may be information about the user, such as dominant hand information. The rule stored in the HMD 101 refers to a priority rule such as a rule that prioritizes an approximately horizontal plane over an approximately vertical plane. The rule is not limited to this, and may be any rule related to plane identification.

Returning to FIG. 6, in step S607, the plane identification unit 402 identifies a plane for input UI placement. The plane identification unit 402 identifies, as a plane for input UI placement, one of the planes detected as candidate planes for input UI placement in the external view video image as described above. The process illustrated in FIG. 6 is then terminated, and the processing in FIG. 5 proceeds to step S503.

Returning to FIG. 5. in step S503, the region identification unit 403 identifies a region for input UI placement within the plane for input UI placement identified in step S502. The region identification unit 403 identifies, for example, a region swiped by the user using a part of the body, such as a finger, as a region for input UI placement within the plane for input UI placement identified in step S502 by the plane identification unit 402. The region identification unit 403 may identify, for example, a region designated by the user using an accessory of the HMD 101, such as a controller, within the plane for input UI placement, as a region for input UI placement. For example, a region excluding an object and stored in advance in the HMD 101 or a region excluding a predetermined object and registered in advance in the HMD 101 may be identified as a region for input UI placement within the plane for input UI placement.

For example, a region excluding a gaze region of the user acquired by the eye imaging apparatus 216 or an empty region within the plane may be identified as a region for input UI placement within the plane for input UI placement. In the case of identifying an empty region within the plane as a region for input UI placement, whether a region is empty may be determined, for example, by dividing the inside of the plane in the external view video image into unit regions and determining whether the similarity between adjacent unit regions is greater than or equal to a threshold. As described above, the region identification unit 403 identifies a region that does not hinder the task performed by the user in the external view video image as a region for input UI placement based on an object included in the external view video image. At this time, a plurality of regions for input UI placement may be identified within the plane for input UI placement.

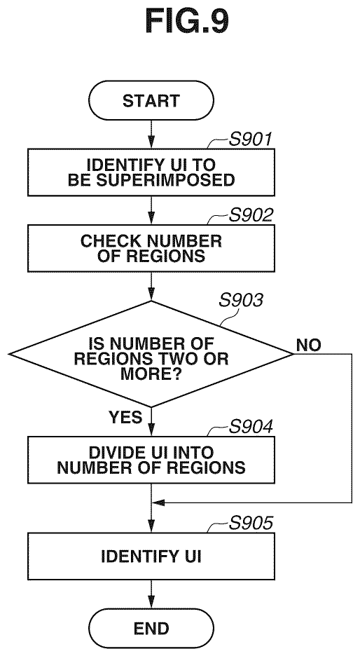

In step S504, the UI identification unit 404 identifies an input UI to be displayed in the region for input UI placement identified in step S503 based on the region for input UI placement identified in step S503. An input UI to be superimposed and displayed is identified from the stored UIs based on user selection or based on a predefined rule stored in the HMD 101. In the case of identifying an input UI to be superimposed and displayed by the user, an input UI to be displayed in the region for input UI placement is identified from the stored UIs based on a user instruction or setting. A process performed by the UI identification unit 404 to identify an input UI to be superimposed and displayed based on the predefined rule stored in the HMD 101 will be described with reference to FIG. 9.

In step S901 in FIG. 9, the UI identification unit 404 identifies an input UI to be superimposed from the input UIs stored in the HMD 101. In a case where a plurality of input UIs is stored in the HMD 101, the UI identification unit 404 identifies an input UI to be superimposed from the plurality of input UIs based on the predetermined rule stored in advance in the HMD 101. Examples of the rule include a rule that calculates the size of the region for input UI placement and identifies an input UI based on the calculated size. The rule is not limited to the above-described rule, and may be any rule for identifying an input UI.

In step S902, the UI identification unit 404 checks the number of regions for input UI placement identified in step S503.

In step S903, the UI identification unit 404 determines whether the number of regions for input UI placement checked in step S902 is two or more. In a case where the UI identification unit 404 determines that the number of regions for input UI placement is two or more (YES in step S903), the processing proceeds to step S904. In a case where the UI identification unit 404 determines that the number of regions for input UI placement is not two or more, i.e., in a case where the UI identification unit 404 determines that the number of regions for input UI placement is one (NO in step S903), the processing proceeds to step S905.

In step S904, the UI identification unit 404 divides the input UI identified in step S901 into the number of regions for input UI placement. The input UI is divided according to a predefined rule. Examples of the predefined rule include a rule that divides the input UI into left and right sections according to the size ratio of the plurality of regions. The rule is not limited to the above-described rule, and may be any rule for dividing the input UI. The user may select a divided input UI, thereby identifying the divided input UI.

In step S905, the UI identification unit 404 identifies an input UI to be displayed in the region for input UI placement. As described above, the UI identification unit 404 identifies an input UI to be superimposed and displayed in the region for input UI placement. The process illustrated in FIG. 9 is then terminated, and the processing in FIG. 5 proceeds to step S505.

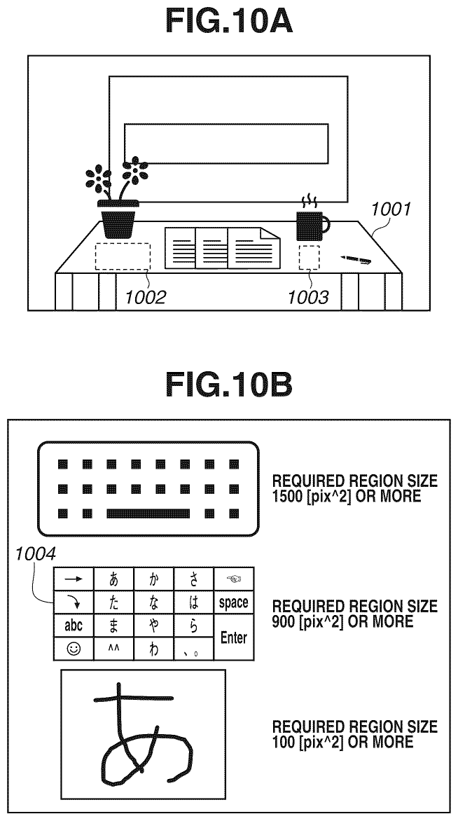

An example of a process in which the UI identification unit 404 identifies an input UI from the plurality of input UIs stored in the HMD 101 based on the region size in a case where two regions are identified as regions for input UI placement by the region identification unit 403 will be described with reference to FIGS. 10A and 10B. Since two or more regions for input UI placement are identified in the above-described case, the input UI is divided according to the predefined rule and displayed in two regions. FIG. 10A is a diagram illustrating the external view video image acquired by the external view acquisition unit 401 and subsequently cropped to match the display field of view of the HMD 101, with dotted lines indicating regions for input UI placement identified by the region identification unit 403. FIG. 10B illustrates examples of the plurality of input UIs stored in the HMD 101 and region sizes required to display each input UI. In FIG. 10A, the resolution is 4096 [pix] vertically and 8192 [pix] horizontally. In the external view video image illustrated in FIG. 10A, a desk 1001 is at the center, and items are placed on the desk 1001. Regions 1002 and 1003 are regions identified by the region identification unit 403. The UI identification unit 404 calculates the size of each region based on coordinate information, and the calculation results are 800 [pix\hat{ }] for the region 1002 and 200 [pix\hat{ }] for the region 1003, bringing the total to 1000 [pix\hat{ }]. The UI identification unit 404 compares the results with the region sizes required for the three types of input UIs illustrated in FIG. 10B and identifies an input UI 1004 as an input UI to be superimposed. Next, the UI identification unit 404 divides the input UI 1004 based on the number of regions for input UI placement according to the predefined rule. In a case where the predefined rule is a rule that divides an input UI into left and right sections according to the size ratio of the plurality of regions, the UI identification unit 404 divides the input UI 1004 according to the ratio of 8:2, which is the size ratio of the regions 1002 and 1003.

Returning to FIG. 5, in step S505, the display control unit 405 controls the left-eye display device 106 and the right-eye display device 107 to display a video image obtained by superimposing the input UI identified in step S504 onto the external view video image in the region identified in step S503. A video image of the virtual reality space obtained by superimposing the input UI identified by the UI identification unit 404 onto the external view image in the region identified by the region identification unit 403 is displayed on the left-eye display device 106 and the right-eye display device 107.

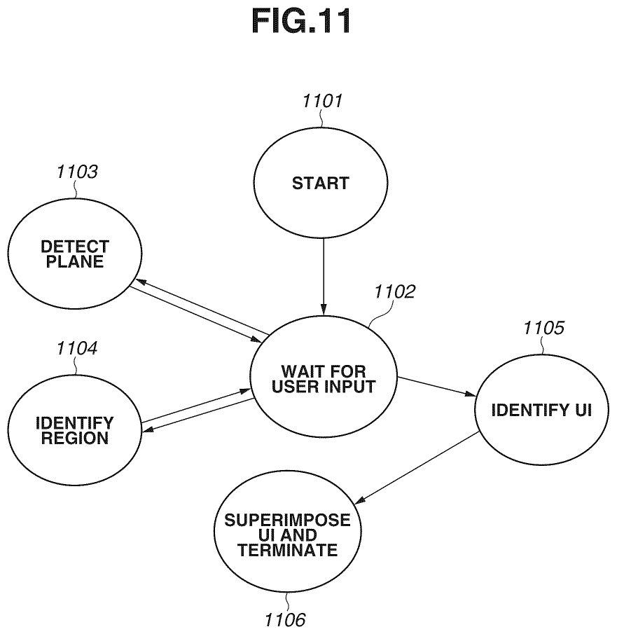

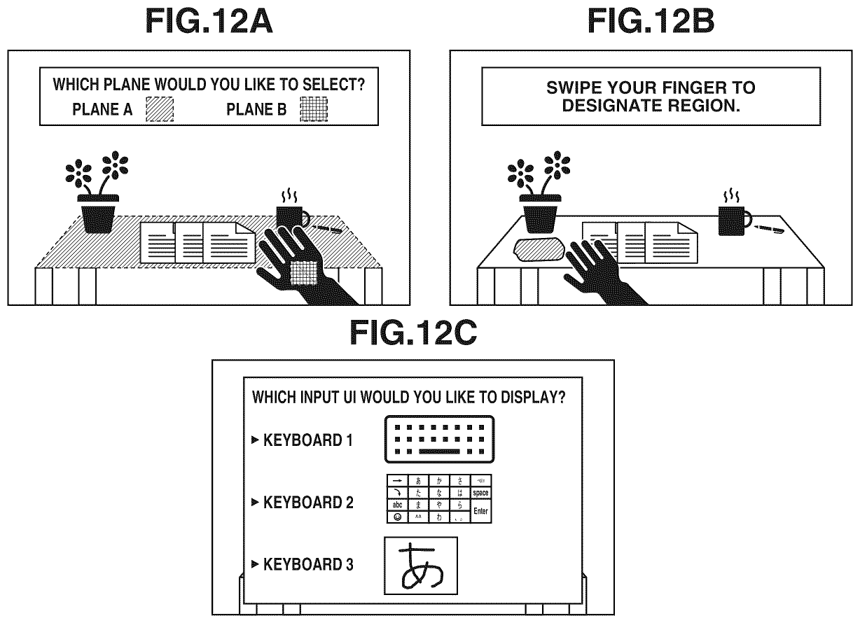

User inputs and user interface operations for displaying an input UI according to the first embodiment will be described. FIG. 11 is a diagram illustrating an example of a state transition diagram illustrating operations of the image processing apparatus. The example illustrated in FIG. 11 illustrates a case where a plane for input UI placement, a region for input UI placement, and an input UI to be displayed are all identified based on user inputs. FIG. 12A to FIG. 12C are diagrams illustrating examples of UIs for receiving user inputs.

Once the image processing apparatus starts an operation for placing an input UI, the image processing apparatus enters a state 1101 and subsequently transitions to a state 1102 to wait for user input. Then, in a case where a user instruction is issued to transition to a mode for identifying input UI placement, the image processing apparatus transitions to a state 1103. In the state 1103, a plane for input UI placement is detected, and the image processing apparatus transitions to the state 1102 to wait for the user to input the plane selection result. FIG. 12A is a schematic diagram illustrating a UI for plane selection. In a case where a plurality of planes is detected by the plane detection in the state 1103, the user selects and identifies a plane for input UI placement via a UI such as the UI illustrated in FIG. 12A. Once a plane is selected by the user, the image processing apparatus transitions to a state 1104. In the state 1104, a region for input UI placement is identified, and the image processing apparatus transitions to the state 1102 to wait for the user to input the region designation result. FIG. 12B is a schematic diagram illustrating a UI for region identification. The user designates a region for input UI placement via a UI such as the UI illustrated in FIG. 12B. Once a region is designated by the user, the image processing apparatus transitions to a state 1105. In the state 1105, an input UI to be displayed is identified. FIG. 12C is a schematic diagram illustrating a UI used by the user to identify an input UI to be displayed. The user identifies an input UI to be displayed via a UI such as the UI illustrated in FIG. 12B. Once an input UI is identified in the state 1105, the image processing apparatus transitions to a state 1106 and superimposes and displays the input UI on the external view video image, the process is terminated.

The first embodiment makes it possible to identify a region for displaying an input UI on a plane detected from an acquired external view video image based on the presence or absence of a specific object. This makes it possible to display a video image of a virtual reality space with the input UI superimposed on the external view video image in a region that does not hinder a task performed by the user based on an object included in the external view video image. For example, it is possible to superimpose and display the input UI on the external view video image in a region other than an approximately flat region where the user does not wish to superimpose the input UI. Accordingly, the first embodiment makes it possible to appropriately display the input UI during the task in the virtual reality space, thus improving work efficiency in the virtual reality space.

### SECOND EMBODIMENT

The first embodiment describes an example of identifying input UI placement on a plane detected from an acquired external view video image based on the presence or absence of a specific object. The object may be moved by the user or the like after identifying input UI placement and superimposing and displaying the input UI on the external view video image. In this case, if the object is moved into the region where the input UI is displayed, the object and the input UI displayed on the external view video image may overlap.

A second embodiment will describe an example of changing the display region of the input UI in a case where the specific object is moved while input UI placement is identified and the input UI is displayed. This makes it possible to constantly superimpose and display the input UI in a region where the specific object is absent even in a case where the specific object is moved while the input UI is displayed, making it possible to improve work efficiency in the virtual reality space. Redundant descriptions of configurations, operations, and the like that are similar to those in the first embodiment are omitted in the following description and only different aspects are described in the second embodiment.

### Functional Configuration of Image processing Apparatus

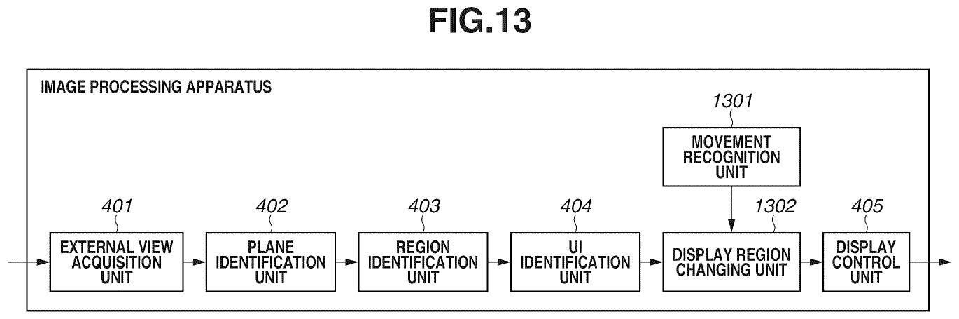

FIG. 13 is a diagram illustrating an example of a functional configuration of an image processing apparatus according to the second embodiment that is implemented using, for example, a circuit. The image processing apparatus according to the second embodiment includes the external view acquisition unit 401, the plane identification unit 402, the region identification unit 403, the UI identification unit 404, the display control unit 405, a movement recognition unit 1301, and a display region changing unit 1302.

The movement recognition unit 1301 recognizes movement of the specific object in the external view, which is the real space, based on input from the imaging apparatus 214 or the sensor 215. The result of recognizing the movement of the object is output to the display region changing unit 1302. In a case where movement of the specific object into the region where the input UI is displayed is recognized by the movement recognition unit 1301, the display region changing unit 1302 repositions the input UI to avoid the specific object and changes the display region of the input UI. The display region changing unit 1302 is an example of a changing unit.

### Process Performed by Image Processing Apparatus

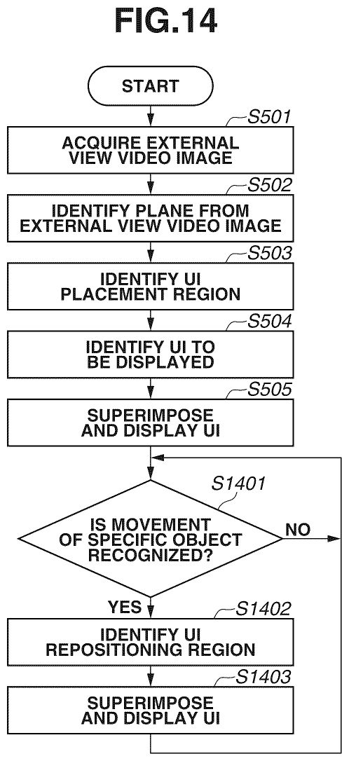

FIG. 14 is a flowchart illustrating a process flow performed by the image processing apparatus according to the second embodiment.

Step S501 to step S505 in FIG. 14 correspond to step S501 to step S505 in FIG. 5. After step S505 is performed, the processing proceeds to step S1401.

In step S1401, the movement recognition unit 1301 recognizes movement of the specific object in the real space (external view video image) based on input from the imaging apparatus 214 or the sensor 215. The movement recognition unit 1301 then determines whether movement of the specific object into the region where the input UI is displayed is recognized. In a case where the movement recognition unit 1301 determines that movement of the specific object into the region where the input UI is displayed is recognized (YES in step S1401), the processing proceeds to step S1402. Unless movement of the specific object into the region where the input UI is recognized (NO in step S1401), step S1401 is repeated.

A process for recognizing movement of the specific object will now be described. Movement of the specific object is recognized based on a video image, signal or the like acquired from the imaging apparatus 214 or the sensor 215 regarding an object stored in advance in the HMD 101, a specific object registered in advance in the HMD 101, or an object of gaze acquired by the eye imaging apparatus 216. Movement of the object based on the video image acquired from the imaging apparatus 214 can be recognized using a publicly known technique such as optical flow. Movement of the object may be recognized using all consecutive frames of the video image acquired from the imaging apparatus 214 or using frames extracted at specific intervals.

Returning to FIG. 14, in step S1402, after movement of the specific object into the region where the input UI is displayed is recognized by the movement recognition unit 1301, the display region changing unit 1302 repositions the input UI to avoid the specific object and changes the display region of the input UI. A region for input UI repositioning is identified based on a region excluding the object that is stored in advance in the HMD 101, a region excluding the specific object that is registered in advance in the HMD 101, a region excluding the gaze region acquired by the eye imaging apparatus 216, an empty region in the plane, and the like. In a case where there is no region for input UI repositioning, the image processing apparatus may provide a notification to prompt the user to move nearby objects or utilize a part of the body, such as a hand, as a plane.

In step S1403, the display control unit 405 controls the left-eye display device 106 and the right-eye display device 107 to display a video image obtained by superimposing the input UI on the external view video image in the region identified in step S1402. A video image of the virtual reality space obtained by superimposing the input UI on the external view image in the display region changed by the display region changing unit 1302 is displayed on the left-eye display device 106 and the right-eye display device 107. The processing then returns to step S1401.

The second embodiment makes it possible to display a video image of a virtual reality space with the input UI superimposed on the external view video image in a region that does not hinder a task performed by the user based on an object included in the external view video image. In a case where the specific object is moved while the input UI is displayed, the display region of the input UI is changed, thereby preventing the object and the input UI displayed on the external view video image from overlapping. This makes it possible to constantly superimpose and display the input UI based on the presence or absence of the specific object even in a case where the specific object is moved while the input UI is displayed. This makes it possible to display the input UI appropriately during a task in the virtual reality space, making it possible to improve work efficiency in the virtual reality space.

### THIRD EMBODIMENT

A third embodiment will describe an example of recognizing a hand state of the HMD wearer and switching a display state of the input UI during a task in the virtual reality space. An image processing apparatus according to the third embodiment switches the display state of the input UI based on whether the recognized hand state of the HMD 101 wearer is a predetermined state. Specifically, in a case where the hand state is a state where a hand is attempting to enter input to the input UI, the image processing apparatus according to the third embodiment superimposes and displays the input UI on the external view video image. In a case where the hand state is a state where a hand is not attempting to enter input, the image processing apparatus according to the third embodiment hides the input UI superimposed on the external view video image. Redundant descriptions of configurations, operations, and the like that are similar to those in the first embodiment are omitted and only different aspects are described below.

### Functional Configuration of Image Processing Apparatus

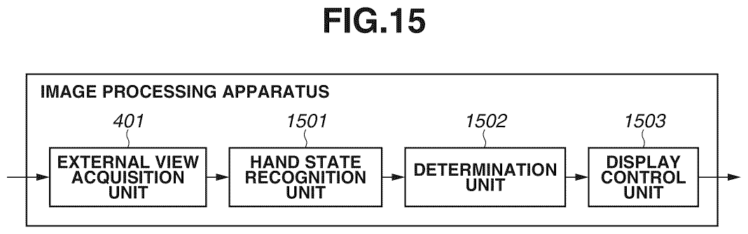

FIG. 15 is a diagram illustrating an example of a functional configuration of the image processing apparatus according to the third embodiment that is implemented using, for example, a circuit. The image processing apparatus according to the third embodiment includes the external view acquisition unit 401, a hand state recognition unit 1501, a determination unit 1502, and a display control unit 1503.

The hand state recognition unit 1501 recognizes the three-dimensional position and state of a hand of the user based on the external view video image acquired by the external view acquisition unit 401. The hand state recognition unit 1501 is an example of a recognition unit. The determination unit 1502 determines whether to superimpose and display the input UI on the external view video image based on the hand state recognized by the hand state recognition unit 1501. The determination unit 1502 is an example of a determination unit. The display control unit 1503 switches the display state of the input UI based on the determination result from the determination unit 1502 and controls the left-eye display device 106 and the right-eye display device 107 to display the video image of the virtual reality space. In the case of superimposing and displaying the input UI on the external view video image, the display control unit 1503 controls the left-eye display device 106 and the right-eye display device 107 to display the video image on which the input UI is superimposed at the three-dimensional position of the hand recognized by the hand state recognition unit 1501. The display control unit 1503 is an example of a display control unit.

### Process Performed by Image Processing Apparatus

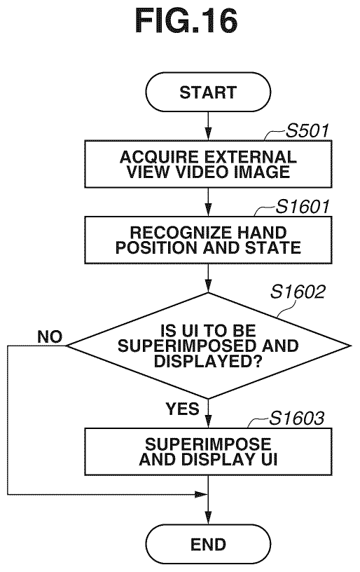

FIG. 16 is a flowchart illustrating a process flow performed by the image processing apparatus according to the third embodiment.

Step S501 in FIG. 16 corresponds to step S501 in FIG. 5. After step S501 is performed, the processing proceeds to step S1601.

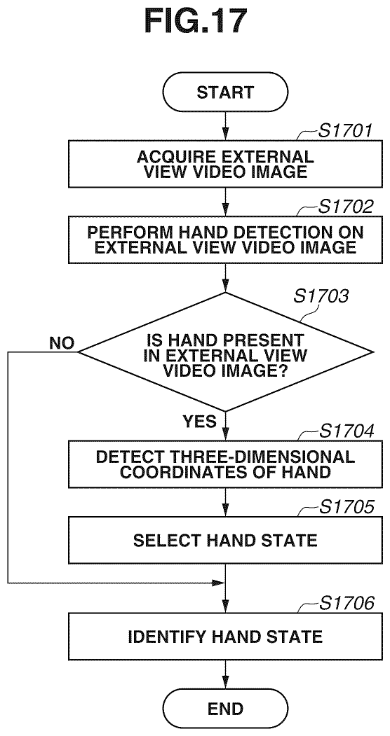

In step S1601, the hand state recognition unit 1501 recognizes the three-dimensional position and hand state of a hand of the HMD wearer based on the external view video image acquired in step S501. This process performed in step S1601 by the hand state recognition unit 1501 to recognize the three-dimensional position and hand state of a hand of the user will be described with reference to FIG. 17.

Turning to FIG. 17, in step S1701, the hand state recognition unit 1501 acquires the external view video image acquired by the external view acquisition unit 401 in step S501.

In step S1702, the hand state recognition unit 1501 performs hand detection on the external view video image acquired in step S1701 to detect a hand of the user. The hand detection can be performed using a publicly known detection process such as a detection method based on a result of edge detection or color detection on the video image or a learning-based processing method using deep learning or the like.

In step S1703, the hand state recognition unit 1501 determines whether a hand is detected from the external view video image in step S1702, i.e., whether a hand is present in the external view video image. In a case where the hand state recognition unit 1501 determines that one hand or both hands are detected from the external view video image (YES in step S1703), the processing proceeds to step S1704. In a case where the hand state recognition unit 1501 determines that no hands are detected from the external view video image (NO in step S1703), the processing proceeds to step S1706.

In step S1704, the hand state recognition unit 1501 detects the three-dimensional coordinates of the hand present in the external view video image. The hand state recognition unit 1501 calculates the three-dimensional coordinates of the hand by, for example, acquiring position information about the hand on the two-dimensional external view video image and position information about the hand in a depth direction (direction perpendicular to the external view video image plane) from the external view video image and information acquired from the sensor 215 of the HMD 101. In a case where both hands are present in the external view video image, the three-dimensional coordinates of the right hand and the three-dimensional coordinates of the left hand are acquired.

In a case where only one hand is present in the external view video image, only the three-dimensional coordinates of the detected hand are acquired.

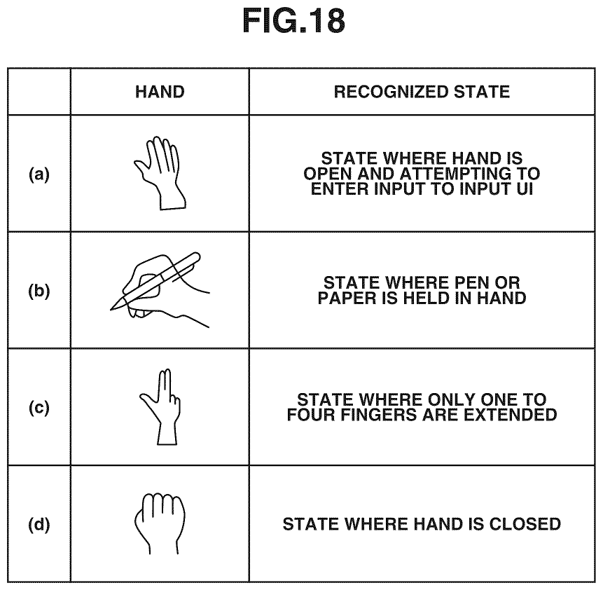

In step S1705, the hand state recognition unit 1501 selects a hand state of the hand present in the external view video image. The hand state can be recognized using a publicly known detection process such as a learning-based processing method using deep learning or the like. FIG. 18 illustrates examples of hand states. The hand states illustrated in FIG. 18 are merely examples indicating whether the hand state is a state where a hand is attempting to enter input into the input UI, and shapes indicating other states may also be used. The examples illustrated in FIG. 18 include a state (a) where a hand is open and attempting to enter input into the input UI, a state (b) where a pen, paper, or the like is held in a hand, a state (c) where only one to four fingers are extended, and a state (d) where a hand is closed is selected. In a case where both hands are present in the external view video image, a hand state is selected for each of the right hand and the left hand, and in a case where only one hand is present in the external view video image, a hand state is selected only for the detected hand.

Returning to FIG. 17, in step S1706, the hand state recognition unit 1501 identifies the state of the hand present in the external view video image.

In a case where it is determined that a hand is absent in the external view video image in step S1703 and the processing proceeds to step S1706, a state where a hand is absent in the external view video image is identified as a hand state. The process illustrated in FIG. 17 is then terminated, and the processing proceeds to step S1602 in FIG. 16.

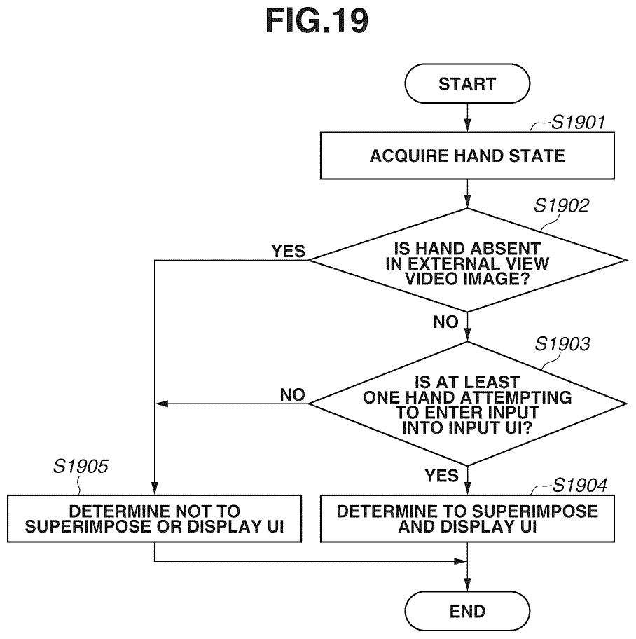

Returning to FIG. 16, in step S1602 the determination unit 1502 determines whether to superimpose and display the input UI on the external view video image based on the hand state recognized in step S1601. The process performed in step S1602 by the determination unit 1502 to determine whether to superimpose and display the input UI will be described with reference to FIG. 19.

Turning to FIG. 19, in step S1901, the determination unit 1502 acquires the hand state recognized by the hand state recognition unit 1501 in step S1601.

In step S1902, the determination unit 1502 determines whether the hand state acquired in step S1901 is a state where a hand is absent in the external view video image. In a case where the determination unit 1502 determines that the hand state is a state where a hand is absent in the external view video image (YES in step S1902), the processing proceeds to step S1905. In a case where the determination unit 1502 determines that the hand state is not a state where a hand is absent in the external view video image, i.e., the hand state is a state where a hand is present in the external view video image (NO in step S1902), the processing proceeds to step S1903.

In step S1903, the determination unit 1502 determines whether the hand state acquired in step S1901 is a state where at least one hand is attempting to enter input into the input UI. For example, in a case where the state of the hand present in the external view video image is the state (a) from among the states illustrated as examples in FIG. 18, the determination unit 1502 determines that the hand state is a state where a hand is attempting to enter input into the input UI. In a case where the determination unit 1502 determines that the hand state is a state where at least one hand is attempting to enter input into the input UI (YES in step S1903), the processing proceeds to step S1904. In a case where the determination unit 1502 determines that the hand state is a state where no hand is attempting to enter input into the input UI (NO in step S1903), the processing proceeds to step S1905.

In step S1904, the determination unit 1502 determines to superimpose and display the input UI, and the process illustrated in FIG. 19 is terminated.

In step S1905, the determination unit 1502 determines not to superimpose or display the input UI, and the process illustrated in FIG. 19 is terminated.

Returning to FIG. 16, in step S1602 in a case where the determination unit 1502 determines to superimpose and display the input UI as described above (YES in step S1602), the processing proceeds to step S1603. In a case where the determination unit 1502 determines not to superimpose or display the input UI (NO in step S1602), the display control unit 1503 performs control to hide the input UI and display the video image of the virtual reality space. The process illustrated in FIG. 16 is then terminated.

In step S1603, the display control unit 1503 controls the left-eye display device 106 and the right-eye display device 107 to display a video image obtained by superimposing the input UI on the external view video image based on the three-dimensional position of the hand recognized in step S1601. A video image of the virtual reality space obtained by superimposing the input UI on the external view image at the three-dimensional position of the hand recognized by the hand state recognition unit 1501 is displayed on the left-eye display device 106 and the right-eye display device 107. The input UI to be superimposed and displayed herein is identified from the input UIs stored in the HMD 101.

The position where the input UI is to be superimposed is identified based on the three-dimensional coordinates of the hand recognized in step S1601. For example, in a case where only the three-dimensional coordinates of one hand are acquired in step S1601, the input UI is placed so that the coordinates of the center of the input UI coincide with the three-dimensional coordinates of the hand. For example, in a case where the three-dimensional coordinates of both hands are acquired in step S1601 and the hand state is a state where only one hand is attempting to enter input, the input UI is placed so that the coordinates of the center of the input UI coincide with the three-dimensional coordinates of the hand attempting to enter input. For example, in a case where the three-dimensional coordinates of both hands are acquired in step S1601 and the hand state is a state where both hands are attempting to enter input, the input UI is placed so that the coordinates of the center of the input UI coincide with the midpoint between the three-dimensional coordinates of the two hands.

According to the third embodiment, the image processing apparatus switches the display state of the input UI on the external view video image based on the state of the hand present in the acquired external view video image. This makes it possible to superimpose and display the input UI on the external view video image in a case where a hand present in the external view video image is in a state of attempting to enter input into the input UI, and hide the input UI superimposed on the external view video image in a case where no hand is in a state of attempting to enter input. Thus, the input UI is not superimposed when the user is not attempting to enter input into the UI, preventing a situation where the displayed input UI hinders other tasks or an erroneous input is entered into the input UI by another task. As described above, the third embodiment makes it possible to display the input UI appropriately during a task in the virtual reality space, making it possible to improve work efficiency in the virtual reality space.

### FOURTH EMBODIMENT

The third embodiment describes an example of superimposing and displaying the input UI on the external view video image in a case where a hand present in the external view video image is in a state of attempting to enter input into the input UI, and hiding the input UI superimposed on the external view video image in a case where no hand is in a state of attempting to enter input. If an input UI for entering input with both hands is displayed when only one hand is attempting to enter input, it may become difficult to press a specific key by one-handed input.

A fourth embodiment will describe an example of changing the input UI to be displayed based on whether only one hand is attempting to enter input or both hands are attempting to enter input at the time of superimposing and displaying the input UI on the external view video image. This makes it possible to superimpose and display an input UI that is easy to operate with one hand in a case where only one hand is to enter input, making it possible to improve work efficiency in the virtual reality space. Redundant descriptions of configurations, operations, and the like that are similar to those in the first and third embodiments are omitted and only different aspects are described in the fourth embodiment.

### Functional Configuration of Image processing Apparatus

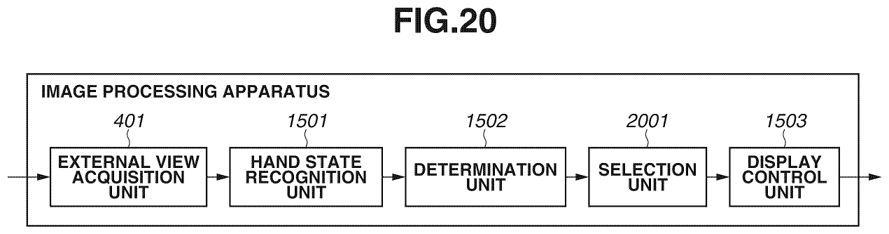

FIG. 20 is a diagram illustrating an example of a functional configuration of an image processing apparatus according to the fourth embodiment that is implemented using, for example, a circuit. The image processing apparatus according to the fourth embodiment includes the external view acquisition unit 401, the hand state recognition unit 1501, the determination unit 1502, the display control unit 1503, and a selection unit 2001. The selection unit 2001 selects an input UI to be superimposed and displayed based on the hand state recognized by the hand state recognition unit 1501. The selection unit 2001 determines whether both hands are attempting to enter input or one hand is attempting to enter input, based on the recognized hand state, and selects an input UI to be superimposed and displayed based on the determination result. The selection unit 2001 is an example of a selection unit.

### Process Performed by Image Processing Apparatus

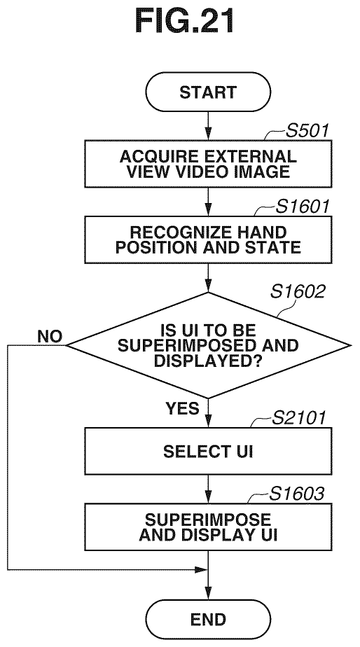

FIG. 21 is a flowchart illustrating a process flow performed by the image processing apparatus according to the fourth embodiment.

Step S501 in FIG. 21 corresponds to step S501 in FIG. 5. After step S501 is performed, the processing proceeds to step S1601.

Step S1601 and step S1602 correspond to step S1601 and step S1602 in FIG. 16. In a case where the determination unit 1502 determines to superimpose and display the input UI in step S1602 (YES in step S1602), the processing proceeds to step S2101. In a case where the determination unit 1502 determines not to superimpose or display the input UI (NO in step S1602), the display control unit 1503 performs control to hide the input UI and display the video image of the virtual reality space. The process illustrated in FIG. 21 is then terminated.

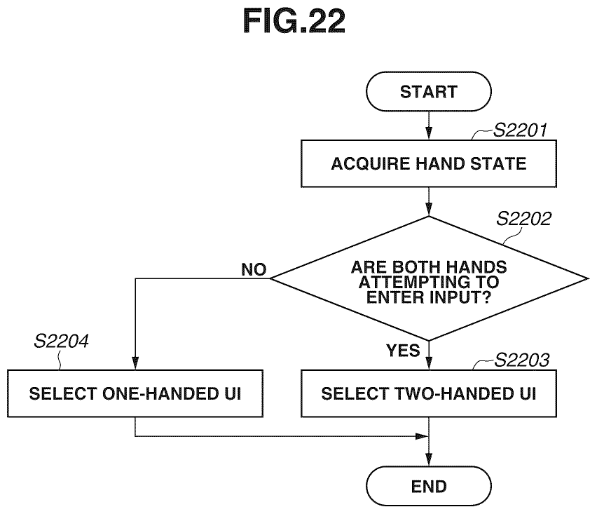

In step S2101, the selection unit 2001 determines whether both hands are attempting to enter input or one hand is attempting to enter input based on the hand state recognized in step S1601 and selects an input UI to be superimposed and displayed based on the determination result. The process performed in step S2101 by the selection unit 2001 to select an input UI to be superimposed and displayed based on the hand state will be described with reference to FIG. 22.

Turning to FIG. 22, in step S2201 the selection unit 2001 acquires the hand state recognized by the hand state recognition unit 1501 in step S1601.

In step S2202, the selection unit 2001 determines whether both hands are present in the external view video image and in a state of attempting to enter input into the input UI based on the hand state acquired in step S2201. In a case where the selection unit 2001 determines that both hands are present in the external view video image and in a state of attempting to enter input into the input UI (YES in step S2202), the processing proceeds to step S2203. In a case where the selection unit 2001 determines that only one hand is in a state of attempting to enter input into the input UI (NO in step S2202), the processing proceeds to step S2204.

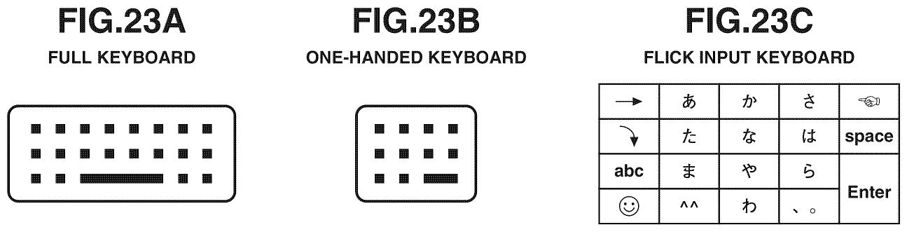

In step S2203, the selection unit 2001 selects a two-handed input UI as an input UI to be superimposed and displayed. Examples of two-handed input UIs include a full keyboard illustrated in FIG. 23A. After the two-handed input UI is selected, the process illustrated in FIG. 22 is terminated, and the processing proceeds to step S1603 in FIG. 21.

In step S2204, since only one hand is attempting to enter input into the input UI, the selection unit 2001 selects a one-handed input UI as an input UI to be superimposed and displayed. Examples of one-handed input UIs include a one-handed keyboard illustrated in FIG. 23B and a flick input keyboard illustrated in FIG. 23C. After the one-handed input UI is selected, the process illustrated in FIG. 22 is terminated, and the processing proceeds to step S1603 in FIG. 21.

Returning to FIG. 21, in step S1603 the display control unit 1503 displays a video image obtained by superimposing the input UI selected in step S2101 on the external view video image, as in step S1603 in FIG. 16. A video image of the virtual reality space obtained by superimposing the input UI selected by the selection unit 2001 based on whether only one hand is attempting to enter input or both hands are attempting to enter input on the external view video image is displayed on the left-eye display device 106 and the right-eye display device 107.

The fourth embodiment makes it possible to superimpose and display the input UI on the external view video image in a case where a hand present in the external view video image is in a state of attempting to enter input into the input UI, and hide the input UI superimposed on the external view video image in a case where no hand is in a state of attempting to enter input. Changing the input UI to be displayed based on whether only one hand is attempting to enter input or both hands are attempting to enter input makes it possible to superimpose and display an input UI that is easy to operate with one hand in a case where input is to be entered with only one hand. This makes it possible to display the input UI appropriately during a task in the virtual reality space, making it possible to improve work efficiency in the virtual reality space.

### FIFTH EMBODIMENT

The fourth embodiment describes an example of changing the input UI based on whether only one hand is attempting to enter input or both hands are attempting to enter input. The user may wish to select settings such as a setting for switching the input UI when the number of hands attempting to enter input changes from two to only one and a setting for selecting the number of seconds to wait before the input UI is switched after the number of hands attempting to enter input changes from two to only one.

A fifth embodiment will describe an example of displaying a setting UI so that the user can set a UI superimposition and display condition in the case of changing the input UI based on whether only one hand is attempting to enter input or both hands are attempting to enter input. This makes it possible for the user to set the UI superimposition and display condition to superimpose and display an input UI as intended by the user, making it possible to improve work efficiency in the virtual reality space. Redundant descriptions of configurations, operations, and the like that are similar to those in the first, third, and fourth embodiments are omitted and only different aspects are described in the fifth embodiment.

### Functional Configuration of Image Processing Apparatus

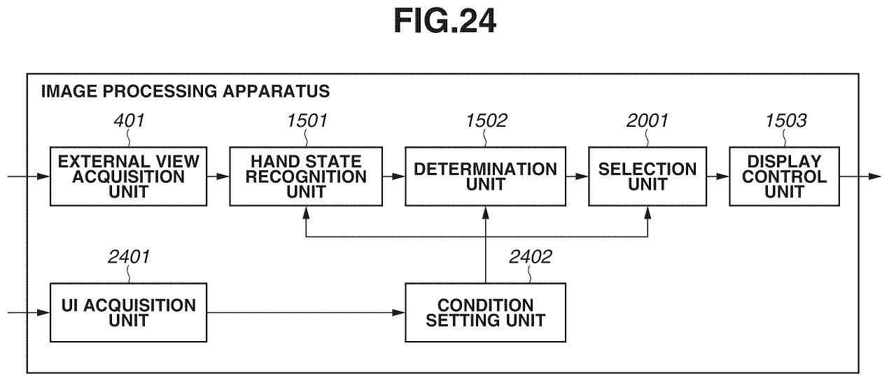

FIG. 24 is a diagram illustrating an example of a functional configuration of an image processing apparatus according to the fifth embodiment that is implemented using, for example, a circuit. The image processing apparatus according to the fifth embodiment includes the external view acquisition unit 401, the hand state recognition unit 1501, the determination unit 1502, the display control unit 1503, the selection unit 2001, a UI acquisition unit 2401, and a condition setting unit 2402. The UI acquisition unit 2401 acquires an available input UI from an application activated in the HMD 101. The condition setting unit 2402 displays a UI (condition setting UI) for setting the input UI superimposition and display condition and the like and acquires a condition set by the user via the condition setting UI or the like. The condition setting unit 2402 is an example of a setting unit.

In the image processing apparatus according to the fifth embodiment, the hand state recognition unit 1501 recognizes the three-dimensional position and state of a hand based on the external view video image acquired by the external view acquisition unit 401 and the condition set by the user and acquired by the condition setting unit 2402. The determination unit 1502 determines whether to superimpose and display an input UI on the external view video image based on the hand state recognized by the hand state recognition unit 1501 and the condition set by the user and acquired by the condition setting unit 2402. The selection unit 2001 selects an input UI to be superimposed and displayed based on the hand state recognized by the hand state recognition unit 1501 and the condition set by the user and acquired by the condition setting unit 2402. The selection unit 2001 determines whether both hands are attempting to enter input or one hand is attempting to enter input based on the recognized hand state and selects an input UI to be superimposed and displayed based on the determination result and the condition set by the user.

### Process Performed by Image Processing Apparatus

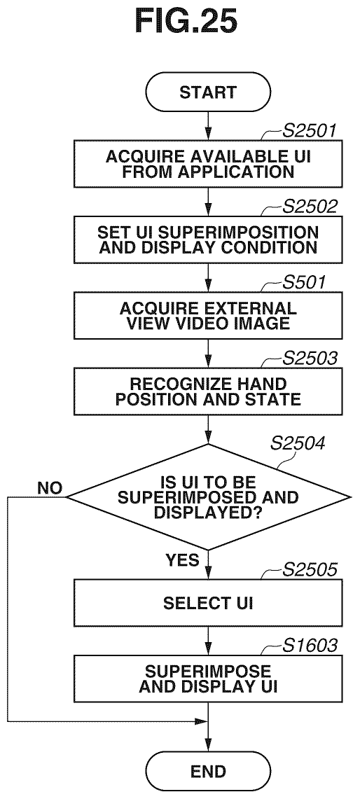

FIG. 25 is a flowchart illustrating a process flow performed by the image processing apparatus according to the fifth embodiment.

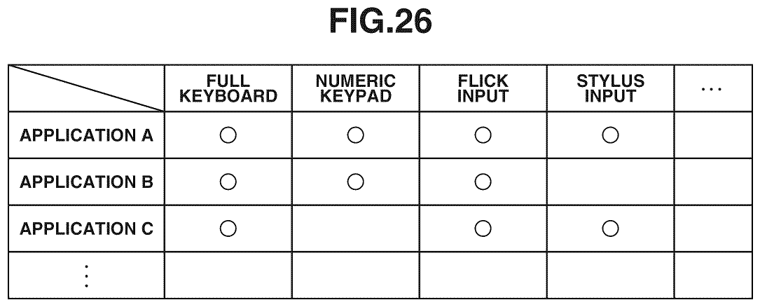

In step S2501, the UI acquisition unit 2401 acquires an available input UI from an application currently activated in the HMD 101. First, the UI acquisition unit 2401 acquires an application name of an application currently activated in the HMD 101. The UI acquisition unit 2401 then acquires an available input UI from the application based on a data list associating application names with available input UIs and the acquired application name. FIG. 26 illustrates an example of a data list associating application names with available input UIs.

The data list is stored in advance, for example, in the RAM 203 in the HMD 101.

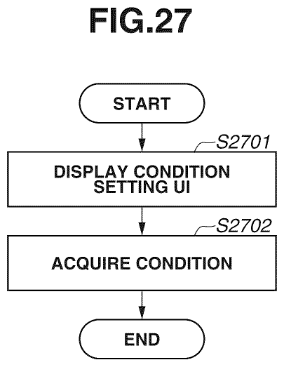

In step S2502, the condition setting unit 2402 displays the condition setting UI for setting the input UI superimposition and display condition and the like and acquires a condition set by the user via the condition setting UI or the like. This process performed in step S2502 by the condition setting unit 2402 to display the condition setting UI and acquire the condition set by the user will be described with reference to FIG. 27.

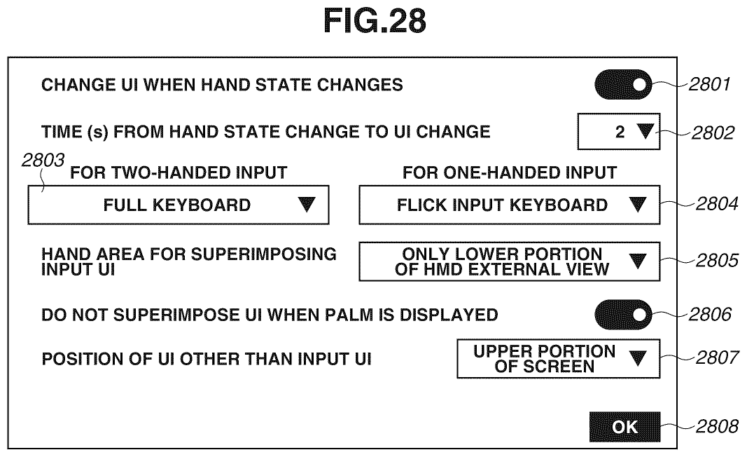

Turning to FIG. 27, in step S2701, the condition setting unit 2402 displays the condition setting UI for setting the superimposition and display condition and the like as illustrated in FIG. 28 on the left-eye display device 106 and the right-eye display device 107. FIG. 28 illustrates an example of the condition setting UI. The condition setting UI illustrated in FIG. 28 is merely an example, the superimposition and display condition and the like that can be set are not limited to those illustrated in FIG. 28, and that a condition to be set and the like can be added or deleted as needed. In the following description, a toggle button (toggle switch) may also be referred to simply as a toggle, and a drop-down menu (pull-down menu) may also be referred to simply as a top-down.

In FIG. 28, a toggle 2801 is used by the user to set whether to change the input UI when the hand state recognized from the external view video image changes. In a case where the setting for not changing the input UI is selected, for example, the displayed input UI is not changed to the one-handed UI even in a case where the number of hands attempting to enter input into the input UI changes from two to only one. A drop-down 2802 is used by the user to set the time (e.g., the number of seconds) from a hand state change to an input UI change in a case where the setting for changing the input UI when the hand state changes is selected. A drop-down 2803 and a drop-down 2804 are used to set an input UI to be superimposed and displayed in a case where both hands are in a state of attempting to enter input into the input UI and an input UI to be superimposed and displayed in a case where only one hand is in a state of attempting to enter input into the input UI. The input UIs that can be set herein are the available UIs acquired from the application in step S2501. A drop-down 2805 is used by the user to set a hand area for superimposing the input UI. For example, in a case where the option “only the lower portion of the HMD external view” is selected, the input UI is superimposed and displayed only when a hand is present at a lower portion of the external view video image acquired in step S501. A toggle 2806 is used by the user to set whether to superimpose and display the input UI in a case where the palm of a hand is displayed in the external view video image. A drop-down 2807 is used by the user to set a position where a UI other than the input UI is to be displayed on the display device in a case where the UI other than the input UI is present. Once the conditions are set using the toggles 2801 and 2806 and the drop-downs 2802 to 2805 and 2807 as needed and a button (OK button) 2808 of the condition setting UI is pressed, the processing proceeds to step S2702.

In step S2702, the condition setting unit 2402 acquires the condition set via the condition setting UI in step S2701. The process illustrated in FIG. 27 is then terminated, and the processing proceeds to step S501 in FIG. 25.

Returning to FIG. 25, step S501 is performed. Step S501 in FIG. 25 corresponds to step S501 in FIG. 5. After step S501 is performed, the processing proceeds to step S2503.

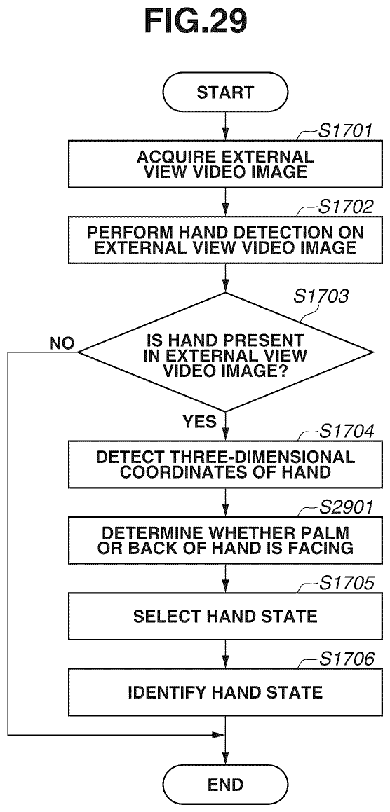

In step S2503, the hand state recognition unit 1501 recognizes the three-dimensional position and state of a hand of the user and also recognizes whether the back or palm of the hand is facing based on the external view video image acquired in step S501. This process performed in step S2503 by the hand state recognition unit 1501 will be described with reference to FIG. 29.

Turning to FIG. 29, step S1701 to step S1704 correspond to step S1701 to step S1704 in FIG. 17. After step S1704 is performed, the processing proceeds to step S2901.

In step S2901, the hand state recognition unit 1501 determines whether the palm or back of the hand present in the external view video image is facing the HMD 101. The orientation of the hand can be determined using a publicly known detection process such as a learning-based processing method using deep learning. After step S2901 is performed, the processing proceeds to step S1705.

Step S1705 and step S1706 correspond to step S1705 and step S1706 in FIG. 17. After the process illustrated in FIG. 29 is terminated, the processing proceeds to step S2504 in FIG. 25.

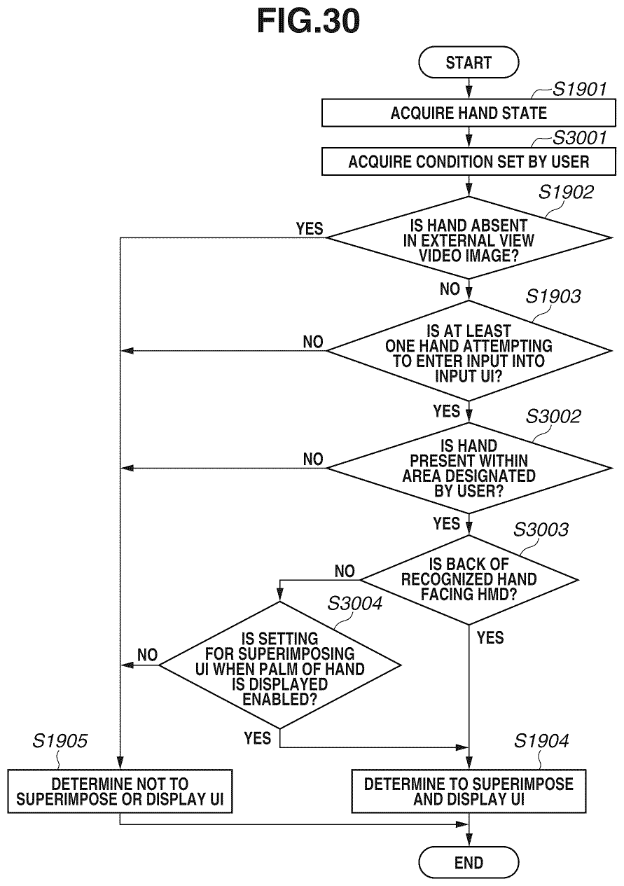

Returning to FIG. 25, in step S2504 the determination unit 1502 determines whether to superimpose and display an input UI on the external view video image based on the condition acquired in step S2502 and the hand state recognized in step S2503. This determination process performed in step S2504 by the determination unit 1502 regarding input UI superimposition and display will be described with reference to FIG. 30.

Turning to FIG. 30, step S1901 corresponds to step S1901 in FIG. 19. After step S1901 is performed, the processing proceeds to step S3001.

In step S3001, the determination unit 1502 acquires the condition set by the user and acquired by the condition setting unit 2402 in step S2502.

Step S1902 and step S1903 correspond to step S1902 and step S1903 in FIG. 19. In a case where the determination unit 1502 determines that at least one hand is in a state of attempting to enter input into the input UI in step S1903 (YES in step S1903), the processing proceeds to step S3002.

In step S3002, the determination unit 1502 determines whether the hand present in the external view video image is present within an area designated by the user based on the condition set by the user and acquired in step S3001. For example, in a case where only a lower portion of the HMD 101 external view is set by the user as a hand area for superimposing the input UI, even when the hand is present at an upper portion of the HMD 101 external view, the determination unit 1502 determines that the hand is not within the area designated by the user. In a case where the determination unit 1502 determines that the hand is present within the area designated by the user in the external view video image (YES in step S3002), the processing proceeds to step S3003. In a case where the determination unit 1502 determines that the hand is not present within the area designated by the user in the external view video image (NO in step S3002), the processing proceeds to step S1905.

In step S3003, the determination unit 1502 determines whether the back of the recognized hand is facing the HMD 101, based on the hand state recognized in step S2503. In a case where the determination unit 1502 determines that the back of the hand is facing (YES in step S3003), the processing proceeds to step S1904. In a case where the determination unit 1502 determines that the palm and not the back of the hand is facing (NO in step S3003), the processing proceeds to step S3004.

In step S3004, the determination unit 1502 determines whether the setting for superimposing and displaying the input UI when the palm of the hand is displayed in the external view video image is enabled based on the condition set by the user and acquired in step S3001. In a case where the determination unit 1502 determines that the setting for superimposing and displaying the input UI when the palm of the hand is displayed in the external view video image is enabled (YES in step S3004), the processing proceeds to step S1904. In a case where the determination unit 1502 determines that the setting for not superimposing or displaying the input UI when the palm of the hand is displayed in the external view video image is enabled (NO in step S3004), the processing proceeds to step S1905.

Step S1904 and step S1905 correspond to step S1904 and step S1905 in FIG. 19. After step S1904 or step S1905 is performed, the processing returns to the process illustrated in FIG. 25.

Returning to FIG. 25, in step S2504 in a case where the determination unit 1502 determines to superimpose and display an input UI (YES in step S2504), the processing proceeds to step S2505. In a case where the determination unit 1502 determines not to superimpose or display an input UI (NO in step S2504), the display control unit 1503 performs control to hide the input UI and display the video image of the virtual reality space and the process illustrated in FIG. 25 is terminated.

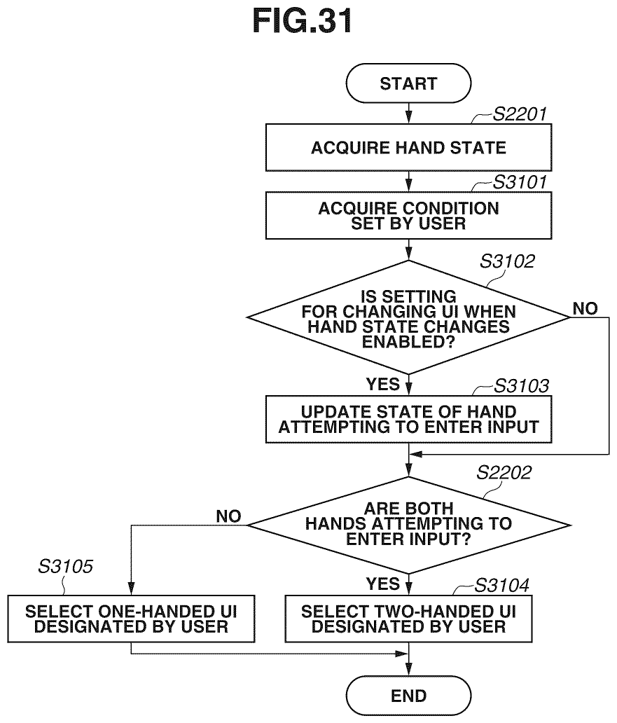

In step S2505, the selection unit 2001 selects an input UI to be superimposed and displayed based on the condition acquired in step S2502 and the hand state recognized in step S2503. The selection unit 2001 determines whether both hands are attempting to enter input or only one hand is attempting to enter input based on the hand state recognized in step S2503, and selects an input UI to be superimposed and displayed based on the condition acquired in step S2502. This process performed in step S2505 by the selection unit 2001 to select an input UI to be superimposed and displayed based on the hand state will be described with reference to FIG. 31.

Turning to FIG. 31, step S2201 in FIG. 31 corresponds to step S2201 in FIG. 22. After step S2201 is performed, the processing proceeds to step S3101.

In step S3101, the selection unit 2001 acquires the condition set by the user and acquired by the condition setting unit 2402 in step S2502.

In step S3102, the selection unit 2001 determines whether the setting for changing the input UI when the hand state changes is enabled based on the condition set by the user and acquired in step S3101. In a case where the selection unit 2001 determines that the setting for changing the input UI when the hand state changes is enabled (YES in step S3102), the processing proceeds to step S3103. In a case where the selection unit 2001 determines that the setting for changing the input UI when the hand state changes is not enabled (NO in step S3102), the processing proceeds to step S2202.

In step S3103, the selection unit 2001 updates information indicating whether the number of hands attempting to enter input is two or one. In a case where the number of hands changes from two to one or from one to two, the selection unit 2001 acquires the condition related to the time from a hand state change to an input UI change based on the condition set by the user and determines whether the state is maintained for the set time. In a case where the selection unit 2001 determines that the changed state is maintained for the set time or longer, information about the state of the hand attempting to enter input is updated. Otherwise, the information about the hand state is not updated. After step S3103 is performed, the processing proceeds to step S2202.

Step S2202 corresponds to step S2202 in FIG. 22.

In step S2202, in a case where the selection unit 2001 determines that both hands are present in the external view video image and in a state of attempting to enter input into the input UI (YES in step S2202), the processing proceeds to step S3104. In a case where the selection unit 2001 determines that only one hand is in a state of attempting to enter input into the input UI (NO in step S2202), the processing proceeds to step S3105.

In step S3104, the selection unit 2001 selects the two-handed input UI set by the user as an input UI to be superimposed and displayed. After the input UI is selected, the process illustrated in FIG. 31 is terminated and the processing proceeds to step S1603 in FIG. 25.

In step S3105, the selection unit 2001 selects the one-handed input UI set by the user as an input UI to be superimposed and displayed. After the input UI is selected, the process illustrated in FIG. 31 is terminated and the processing proceeds to step S1603 in FIG. 25.

Returning to FIG. 25, in step S1603 the display control unit 1503 displays a video image obtained by superimposing the input UI selected in step S2505 on the external view video image, as in step S1603 in FIG. 16. A video image of the virtual reality space obtained by superimposing the input UI intended by the user on the external view video image based on the user settings is displayed on the left-eye display device 106 and the right-eye display device 107.

The fifth embodiment makes it possible for the user to set the UI superimposition and display condition to superimpose and display an input UI as intended by the user, making it possible to display an input UI as appropriate and improve work efficiency in the virtual reality space.

### Other Embodiments

In the first embodiment, a user notification may be issued to prompt the user to change the plane detection method in a case where no candidate plane for input UI placement is detected from the external view video image. An example may be a change in the size of a region to be detected, but other methods may also be used.

In the third to fifth embodiments, the state of the hand attempting to enter input into the input UI may be a state where the hand is open or may be a state where only one to four fingers are extended to attempt to operate the input UI. In a case where the input UI is designed for handwritten character input, the state of the hand attempting to enter input may be a state where an attempt is being made to write a character with a finger or a state where a pen is held in the hand. The state of the hand not attempting to enter input may be a state where the palm of the hand is facing the HMD 101 or a state where both hands are joined.

The above-described embodiments may be combined as needed. For example, the third embodiment may be applied to the first or second embodiment to switch the display state of the input UI based on the hand state in the external view video image.

### Other Embodiments of the Present Disclosure

The present disclosure can also be realized by a process in which a program configured to realize one or more functions of the above-described embodiments is supplied to a system or an apparatus via a network or a storage medium and one or more processors of a computer of the system or the apparatus read and execute the program. Further, the present disclosure can also be realized by a circuit (e.g., an application-specific integrated circuit (ASIC)) configured to realize the one or more functions.

The above-described embodiments are merely examples of implementation of the present disclosure and should not be interpreted as limiting the technical scope of the present disclosure. In other words, the present disclosure can be implemented in various forms without departing from the technical concept or major features.

The present disclosure makes it possible to display an input UI appropriately during a task in a virtual reality space.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-172752, filed Oct. 1, 2024, which is hereby incorporated by reference herein in its entirety.

What is claimed is:

1. An image processing apparatus comprising:
an acquisition unit configured to acquire a video image of a real space that is obtained by imaging an area in front of a user wearing the image processing apparatus;
a region identification unit configured to identify a region that is a candidate plane for displaying a user interface enabling the user to enter input in the video image of the real space based on an object included in the acquired video image of the real space; and
a display control unit configured to control display of a video image obtained by superimposing the user interface on the video image of the real space in the identified region.

2. The image processing apparatus according to claim 1, further comprising a user interface identification unit configured to identify the user interface to be displayed in the identified region.

3. The image processing apparatus according to claim 2, wherein the user interface identification unit identifies the user interface to be displayed from a stored user interface based on selection made by the user or a size of the identified region.

4. The image processing apparatus according to claim 1, further comprising a plane identification unit configured to detect a candidate plane for placing the user interface from the acquired video image of the real space and identify a plane for placing the user interface from the detected plane,
wherein the region identification unit identifies the region for displaying the user interface within the identified plane.

5. The image processing apparatus according to claim 1, wherein the region identification unit identifies a region that excludes a predetermined object as the region for displaying the user interface in the video image of the real space.

6. The image processing apparatus according to claim 1, wherein the region identification unit identifies a region designated by the user as the region for displaying the user interface in the video image of the real space.

7. The image processing apparatus according to claim 1, further comprising an imaging unit configured to image an eye state of the user,
wherein the region identification unit identifies a region that excludes a gaze region of the user acquired by the imaging unit as the region for displaying the user interface in the video image of the real space.

8. The image processing apparatus according to claim 1, further comprising a changing unit configured to change the region for displaying the user interface in the video image of the real space in a case where movement of a predetermined object included in the video image of the real space is recognized.

9. The image processing apparatus according to claim 1, wherein the user interface is divided into the region and displayed based on the identified region.

10. The image processing apparatus according to claim 1, further comprising a determination unit configured to determine whether to display the user interface based on a hand state of the user in the acquired video image of the real space,
wherein the display control unit switches a display state of the user interface on the video image of the real space based on a result of the determination.

11. The image processing apparatus according to claim 10, wherein the determination unit determines to, in a case where the hand state of the user in the video image of the real space is a predetermined state, display the user interface.

12. The image processing apparatus according to claim 11, wherein the predetermined state is a state of attempting to enter input into the user interface.

13. An image processing apparatus comprising:
an acquisition unit configured to acquire a video image of a real space that is obtained by imaging an area in front of a user wearing the image processing apparatus;
a recognition unit configured to recognize a hand state of the user in the acquired video image of the real space;
a determination unit configured to determine whether to display a user interface enabling the user to enter input based on the recognized hand state of the user; and
a display control unit configured to control display of a video image obtained by superimposing the user interface on the video image of the real space based on a result of the determination.

14. The image processing apparatus according to claim 13,
wherein the recognition unit recognizes a three-dimensional position of a hand of the user in the video image of the real space, and
wherein the display control unit superimposes the user interface on the video image of the real space based on the recognized three-dimensional position of the hand of the user.

15. The image processing apparatus according to claim 13, wherein the determination unit determines to, in a case where the hand state of the user in the video image of the real space is a predetermined state, display the user interface.

16. The image processing apparatus according to claim 15, wherein the predetermined state is a state of attempting to enter input into the user interface.

17. The image processing apparatus according to claim 13, wherein the determination unit determines to, in a case where the hand state of the user in the video image of the real space is not a predetermined state, hide the user interface.

18. The image processing apparatus according to claim 13, further comprising a selection unit configured to select the user interface to be displayed based on whether the recognized hand state of the user indicates that both hands are in a predetermined state or one hand is in the predetermined state.

19. The image processing apparatus according to claim 18, wherein the selection unit changes the user interface to be displayed in a case where the recognized hand state of the user changes.

20. The image processing apparatus according to claim 19, further comprising a setting unit configured to set whether to change the user interface to be displayed in a case where the recognized hand state of the user changes.

21. An image processing method comprising:
acquiring a video image of a real space that is obtained by imaging an area in front of a user wearing an image processing apparatus;
identifying a region that is a candidate plane for displaying a user interface enabling the user to enter input in the video image of the real space based on an object included in the acquired video image of the real space; and
controlling display of a video image obtained by superimposing the user interface on the video image of the real space in the identified region.

22. An image processing method comprising:
acquiring a video image of a real space that is obtained by imaging an area in front of a user wearing an image processing apparatus;
recognizing a hand state of the user in the acquired video image of the real space;
determining whether to display a user interface enabling the user to enter input based on the recognized hand state of the user; and
controlling display of a video image obtained by superimposing the user interface on the video image of the real space based on a result of the determining.

23. A non-transitory computer-readable storage medium storing a program for causing a computer to perform an image processing method, the image processing method comprising:
acquiring a video image of a real space that is obtained by imaging an area in front of a user wearing an image processing apparatus;
identifying a region that is a candidate plane for displaying a user interface enabling the user to enter input in the video image of the real space based on an object included in the acquired video image of the real space; and
controlling display of a video image obtained by superimposing the user interface on the video image of the real space in the identified region.

24. A non-transitory computer-readable storage medium storing a program for causing a computer to perform an image processing method, the image processing method comprising:
acquiring a video image of a real space that is obtained by imaging an area in front of a user wearing an image processing apparatus;
recognizing a hand state of the user in the acquired video image of the real space;
determining whether to display a user interface enabling the user to enter input based on the recognized hand state of the user; and
controlling display of a video image obtained by superimposing the user interface on the video image of the real space based on a result of the determining.
